(19) United States
(12) Patent Application Publication
(10) Pub. No.: US 2006/0271546 A1
(43) Pub. Date: Nov. 30, 2006

(54) Method, apparatus and computer program for searching multiple information sources

(75) Inventor: Nhut Xan Phung, Burwood, New South Wales (AU)

Correspondence Address: WOOD, PHILLIPS, KATZ, CLARK & MORTIMER, 500 W. MADISON STREET, SUITE 3800, CHICAGO, IL, 60661, US

(73) Assignee: Health Communication Network Limited, Crows Nest, New South Wales (AU)

(21) Appl. No.: 10/560,541

(22) PCT Filed: Mar. 31, 2005
(86) PCT No.: PCT/AU05/00454

§ 371 Date: May 25, 2006

(30) Foreign Application Priority Data
Apr. 2, 2004 (AU) 2004901798

(51) Int. Cl. G06F 17/30

(52) U.S. Cl. 707/10

(57) ABSTRACT

Method, apparatus and computer program products for searching a plurality of information sources are disclosed herein. One method comprises the steps of mapping a search string to a plurality of search terms wherein each search term relates to at least one of the plurality of information sources (810), and searching at least one information source using selected ones of the search terms (830). The method may comprise the optional further step of indicating at least one information source that each search term relates to (820). The apparatus and computer program product may be used to practice embodiments of the foregoing method.

### FIELD OF THE INVENTION

The present invention relates to information sources and more particularly to searching multiple machine-readable information sources.

### BACKGROUND

String searching (e.g., by keyword or phrase) represents one of the most common forms of searching performed on machine-readable information sources or databases. Search strings may also be combined using Boolean operators to perform so-called Boolean searches.

Successful searching is generally dependent on an appropriate selection of search strings. For more specialised information sources, such as those relating to a specialised field or art, selection of suitable search strings requires knowledge of specific terms used in the particular field or art. Thus, searching the most relevant information sources may not yield optimal results if the appropriate string is not selected as the basis for the search. One such specialised field is that of biomedical science.

MEDLINE is a bibliographic database published by the U.S. National Library of Medicine (NLS) that covers the fields of medicine, nursing, dentistry, veterinary medicine, the health care system, and the preclinical sciences. MEDLINE provides access to abstracts of articles and citations from more than 4,000 biomedical journals published worldwide.

The Medical Subject Headings (MeSH®) is a controlled vocabulary produced by the NLS that may be used for indexing, cataloguing, and searching for biomedical and health-related information and documents. Various online systems provide access to MeSH®. Such systems include the MeSH® Browser, which contains the complete contents of the vocabulary, the MeSH® Entrez databases, which are designed to assist those searching MEDLINE or PubMED, and the UMLS Metathesaurus®, wherein the MeSH® vocabulary is combined with a number of other controlled vocabularies. The UMLS Metathesaurus® is designed to facilitate retrieval and integration of information from multiple machine-readable information sources such as descriptions of the biomedical literature, clinical records, factual databanks, knowledge-based systems, and directories of people and organisations and are specifically directed to developers of information retrieval systems.

Numerous organisations offer access to the MEDLINE database with differing ways of searching the database. One such MEDLINE service is the PubMED service offered by the U.S. National Library of Medicine (NLM). Another MEDLINE service using MeSH® is offered by Ovid Technologies, Inc.

Another bibliographic database that provides access to literature on pharmacology and bio-medicine is EMBASE, which is produced by Elsevier Science B.V. Various organisations offer access to the EMBASE database with differing searching methods and vocabularies. For example, Ovid offers access to EMBASE using the EMTREE vocabulary.

As may be understood from the foregoing, numerous separate information sources relating to the biomedical field are published worldwide as electronic resources or databases. However, major obstacles to the effective retrieval and integration of information from multiple sources deter medical and health-care professionals and researchers from using available machine-readable information. Such obstacles include:
the large variety of vocabularies and classifications used in different sources and by different users, and
the sheer number and wide distribution of potentially relevant information sources.

Some existing mechanisms for searching machine readable information sources such as Ovid and PubMED provide a limited facility to map search strings to alternative search terms, particularly when multiple information sources are required to be searched.

A need thus exists for improved methods, apparatuses and computer programs for searching multiple information sources.

### SUMMARY

According to an aspect of the present invention, there is provided a method for searching a plurality of machine-readable information sources. The method comprises the steps of:
mapping a search string to a plurality of search terms, wherein each search term relates to at least one of the plurality of information sources;
indicating at least one information source that each search term relates to; and
searching at least one indicated information source using selected ones of the search terms.

According to another aspect of the present invention, there is provided an apparatus for searching a plurality of machine-readable information sources. The apparatus comprises:
a communications interface for transmitting and receiving data;
a memory unit for storing data and instructions to be performed by a processing unit; and
a processing unit coupled to the communications unit and the memory unit, the processing unit programmed to:
map a search string to a plurality of search terms, wherein each search term relates to at least one of the plurality of information sources;
output an indication of at least one information source that each search term relates to; and
search at least one indicated information source using selected ones of the search terms.

According to another aspect of the present invention, there is provided a computer program product comprising a computer readable medium having a computer program recorded therein for searching a plurality of information sources. The computer program product comprises:
computer program code for mapping a search string to a plurality of search terms, wherein each search term relates to at least one of the plurality of information sources;
computer program code for outputting an indication of at least one information source that each search term relates to; and
computer program code for searching at least one indicated information source using selected ones of the search terms.

Indication of an information source that a search term relates to may comprise indicating which of a plurality of information sources each search terms relates to and/or indicating which vocabulary each search term is included in, wherein each vocabulary relates to at least one information source.

The search terms may be selected from a vocabulary of terms used in a related one of the plurality of information sources or from a meta-vocabulary comprising a list of terms included in a plurality of vocabularies.

According to yet another aspect of the present invention, there is provided a method for searching a plurality of machine-readable information sources comprising the steps of:
mapping a search string to a plurality of search terms, wherein each search term relates to at least one of the plurality of information sources; and
searching at least one information source using selected ones of the search terms.

Other aspects of the present invention comprise an apparatus and a computer program product for practising the foregoing method.

### BRIEF DESCRIPTION OF THE DRAWINGS

Existing and new embodiments are described hereinafter, by way of example only, with reference to the accompanying drawings in which:

FIG. 1 is a screenshot showing input of a string to an Ovid searching tool;

FIG. 2 is a screenshot showing a mapping display for the string input in FIG. 1;

FIG. 3 is a screenshot showing results of a search of an Ovid-delivered version of the EMBASE database;

FIG. 4 is a screenshot showing a menu for changing database;

FIG. 5 is a screenshot showing results of a search performed on an Ovid-delivered version of the MEDLINE database;

FIG. 6 is a screenshot showing a mapping display;

FIG. 7 is a screenshot showing results of a search performed on an OVID-delivered version of the MEDLINE database;

FIG. 8 is a flow diagram of a method for searching a plurality of machine-readable information sources according to an embodiment of the present invention;

FIG. 9 is a screenshot showing input of a search string to the Universal Search Environment (USE) searching tool;

FIG. 10 is a screenshot showing a mapping display for the search string input in FIG. 9;

FIG. 11 is a screenshot showing results of two searches performed on the Ovid MEDLINE and EMBASE databases, respectively;

FIG. 12 is a screenshot showing a menu for changing database and results of a search performed on the Ovid EMBASE database;

FIG. 13 is a screenshot showing results of two separate searches performed on the Ovid EMBASE databases;

FIG. 14 is a schematic block diagram of a computer system with which embodiments of the present invention may be practised;

FIG. 15 is a screenshot showing input of a search string to the Universal Search Environment (USE) searching tool;

FIG. 16 is a screenshot showing a mapping display for the string input in FIG. 15; and

FIG. 17 is a screenshot showing a dropped-down instance of a field selection menu.

### DETAILED DESCRIPTION

A small number of embodiments are described hereinafter for searching a plurality of information sources. For ease of description, the embodiments are described with specific reference to medical sources or databases. However, it is not intended that the present invention be limited accordingly as the principles of the present invention have general applicability to numerous other machine-readable information sources or databases.

The word “vocabulary”, as used in the present specification, is intended to include both published and proprietary lists of words or terms within the scope thereof. A “vocabulary” may be generated based on terms that are used in a particular database or may simply comprise a general list of terms used in a specific field or art.

The word “term”, as used in the present specification, is intended to include both words and phrases within the scope thereof. A meta-vocabulary or meta-thesaurus typically comprises a consolidated list of terms that are or may be used in multiple information sources. “Synonyms” or terms that have an equivalent conceptual meaning are typically grouped together as a “subject” in a meta-vocabulary. Details of a source vocabulary from which a synonym originates are also typically stored in a meta-vocabulary. An “alternative subject” is another subject that is closely related but not identical to the original subject.

The phrase “information source”, as used in the present specification, includes both structured and unstructured databases within the intended scope thereof. Examples of structured and unstructured databases include bibliographic databases and machine-readable textbooks, respectively.

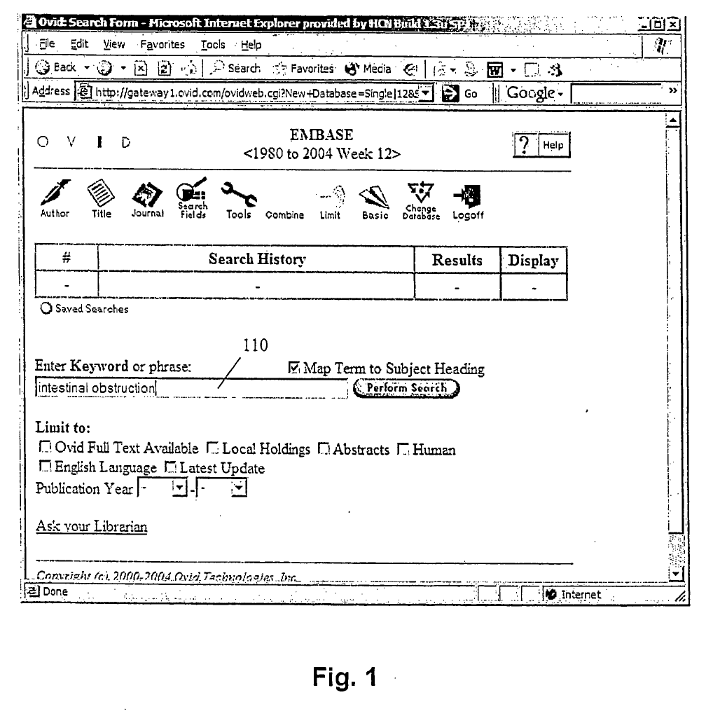

FIGS. 1 to 7 relate to an existing embodiment of a method for searching information sources offered by Ovid Technologies, Inc.

FIG. 1 shows input of the string “intestinal obstruction” 110 to Ovid.

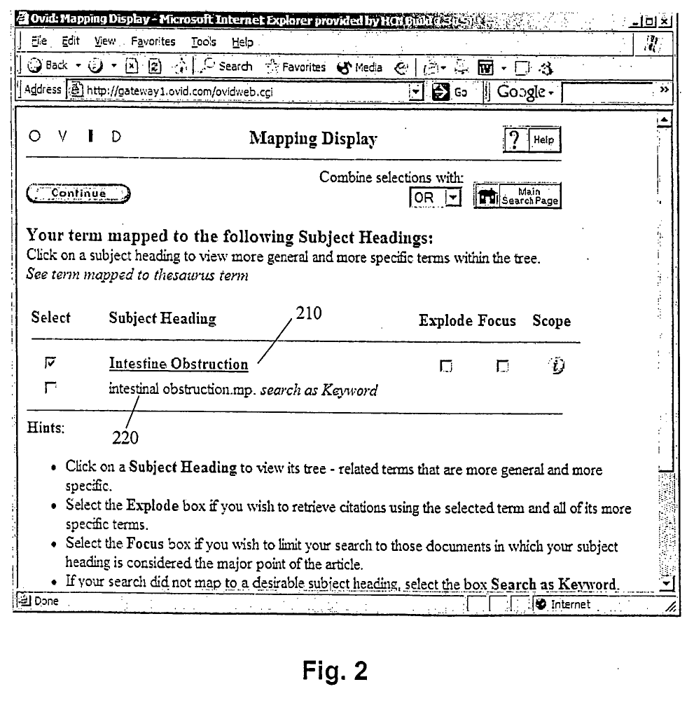

FIG. 2 shows mapping of the original string 110 by Ovid to the search term “Intestine Obstruction” 210 using EMTREE. Ovid also offers a simple keyword- or phrase-type search based on the original string 110, which is shown as search term 220 in FIG. 2. The ticks in the boxes to the left of the possible search terms 210 and 220 indicate user selection of the search term 210 and non-selection of the search term 220 for searching.

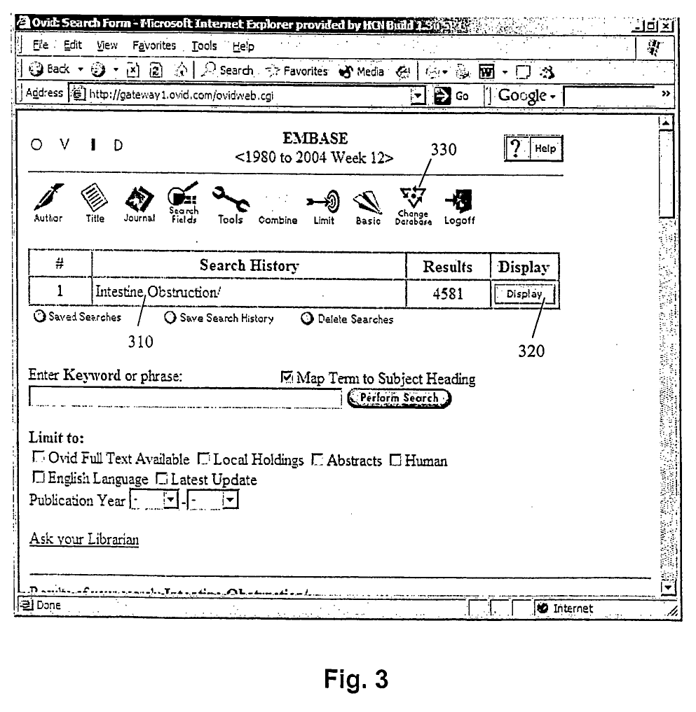

FIG. 3 shows that 4581 matches resulted from searching the Ovid-delivered version of the EMBASE database using the search term 310 from EMTREE, which corresponds to the search term 210 in FIG. 2. Activation of the display icon 320 by means of a pointing device causes the actual search results to be displayed. The “Change Database” icon 330 may be activated to change from EMBASE to another database offered by Ovid.

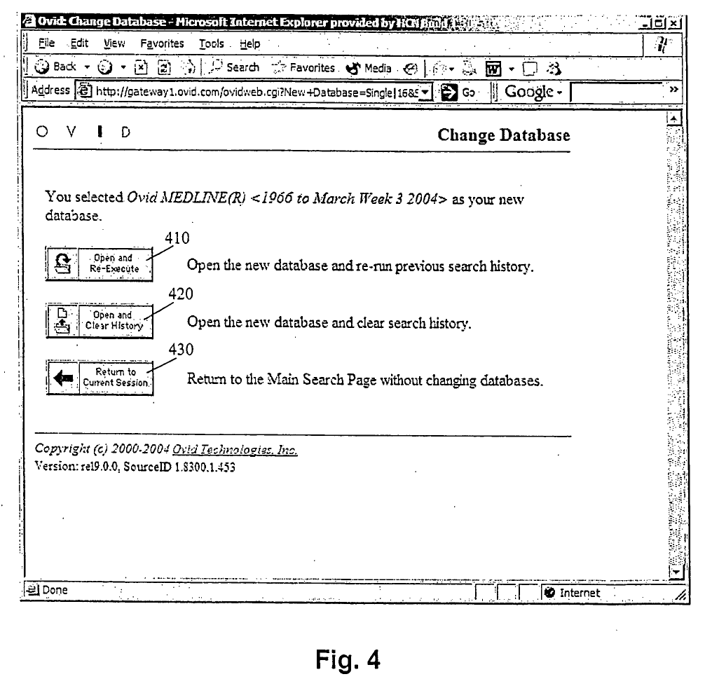

FIG. 4 shows a menu for changing from the EMBASE database to the MEDLINE database. Menu option 410 opens the MEDLINE database and re-runs the previous search history. Menu option 420 opens the MEDLINE database and clears the search history. Menu option 430 returns a user to the Main Search Page without changing databases.

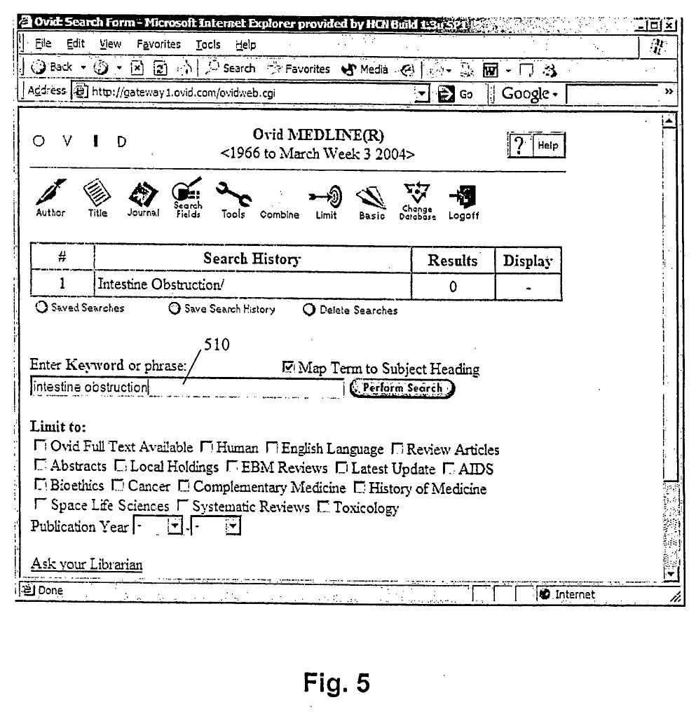

FIG. 5 shows the result of selecting menu option 410 in FIG. 4 and thus opening the MEDLINE database and re-executing the search using the same search term as that used in the previous search. FIG. 5 shows that zero matches were found by searching the OVID-delivered version of the MEDLINE database using the search term “Intestine Obstruction” 510 from EMTREE, which corresponds to the search term 210 in FIG. 2. The zero result is due to the fact that the search term 510 is not a MeSH® term for searching the MEDLINE database.

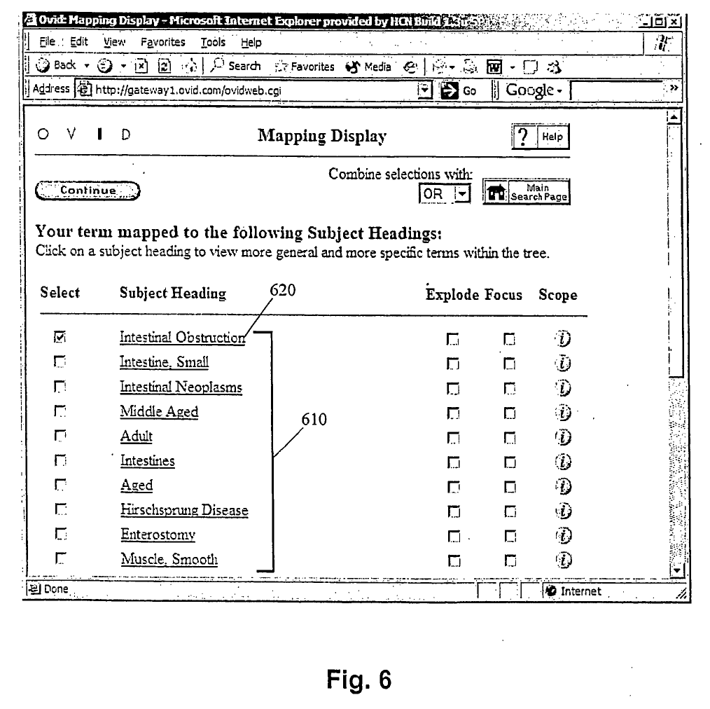

FIG. 6 shows a list of subjects 610 for remapping the search term “Intestine Obstruction”, which corresponds to the search term 510 in FIG. 5. A user may select or deselect each of the various subjects 610 by ticking or un-ticking the boxes to the left of each subject. FIG. 6 shows only the subject “Intestinal Obstruction” 620 selected by way of the tick in the box to the left of the subject 620. The boxes relating to and to the left of the remaining subjects are un-ticked.

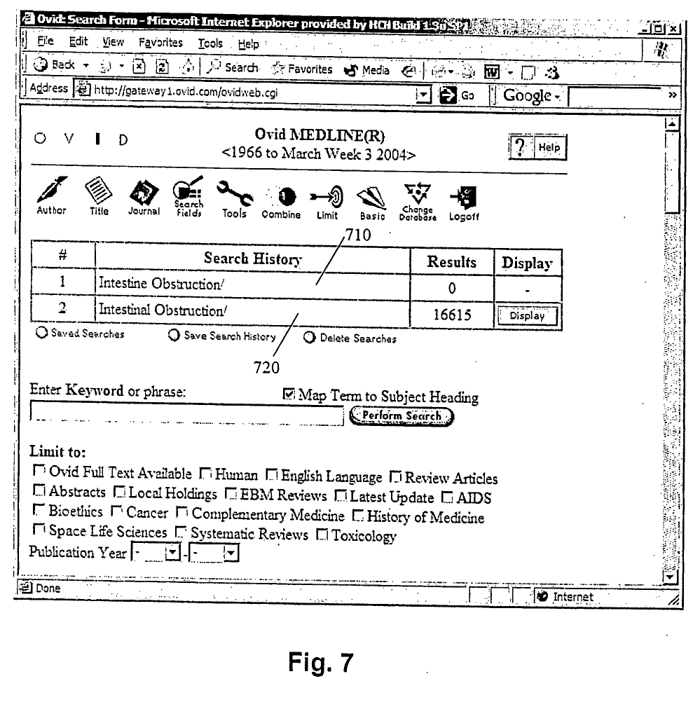

FIG. 7 shows results of searches performed on the Ovid-delivered version of the MEDLINE database. Zero matches were found using the search term “Intestine Obstruction” 710 from EMTREE, whereas 16615 matches were found using the search term “Intestinal Obstruction” 720 from MeSH®.

FIGS. 1 to 7 show that re-execution of a search on a different information source using Ovid does not yield optimal results as the mapping of an original string to a plurality of alternative terms is not optimal for a different information source. Optimal searching of a different information source using Ovid thus requires the extra step of re-mapping the original string on a vocabulary related to, or used to index, the different information source. Furthermore, Ovid disadvantageously fails to provide any indication of the information sources or vocabularies the various subjects or search terms originate from or are related to.

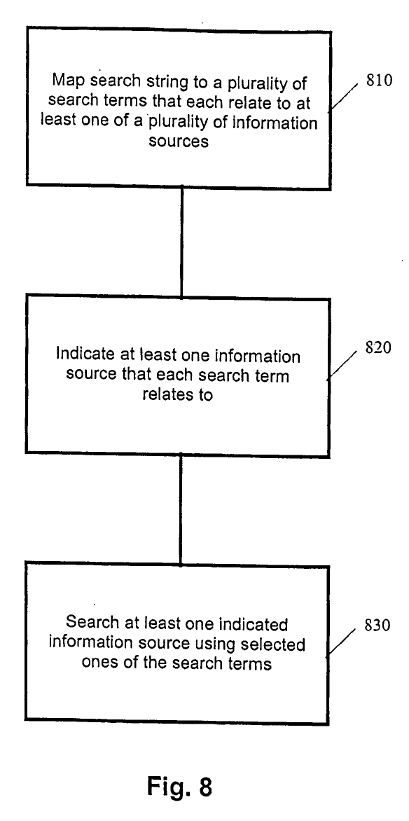

FIG. 8 is a flow diagram of a method for searching a plurality of machine-readable information sources.

At step 810, a search string is mapped to a plurality of search terms that are each included in at least one vocabulary relating to at least one of the plurality of information sources. An indication of at least one information source that each search term relates to is provided at step 820. Step 820 is an optional step in that it is not included in certain embodiments of the present invention. At least one indicated information source is searched at step 830 using selected ones of the search terms.

The information source/s that the search terms relate to is/are indicated to provide reassurance to a user that an appropriate mapping to search terms relating to desired vocabularies or information sources is performed or available. The information source/s that the search terms relate to may be indicated by displaying references to one or more vocabularies related to each search term and/or one or more information sources related to each search term, or both. As all of the search terms are presented across searches, additional searches may be performed on multiple information sources without the need for re-mapping of the search terms each time a different information source is searched.

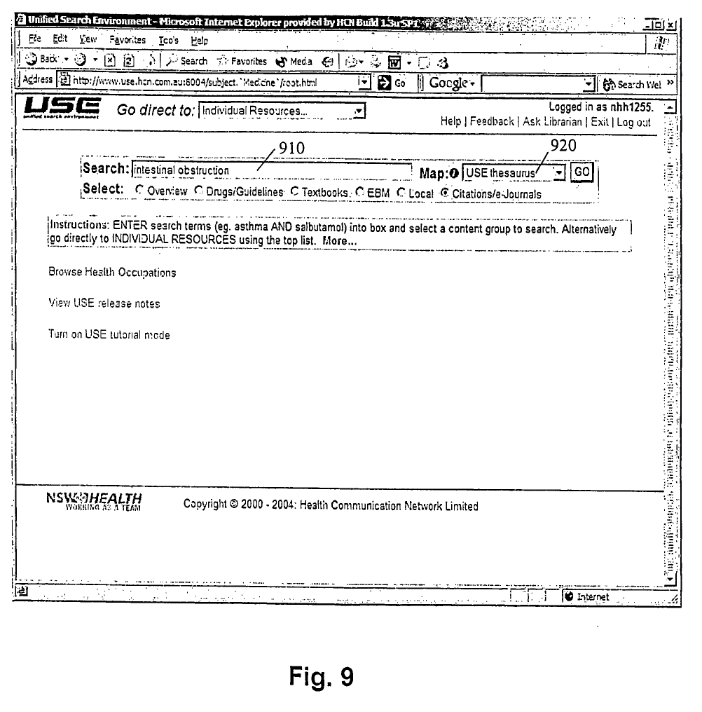

FIGS. 9 to 13 relate to an embodiment of the method of FIG. 8.

FIG. 9 shows input of the search string “intestinal obstruction” 910 to the Unified Search Environment (USE), which comprises a computer software program. Mapping of the search term 910 is performed by user selection of a “thesaurus” option 920. Other options in place of the thesaurus option include a simple search using a keyword or phrase. The thesaurus used by USE is based on the UMLS Metathesaurus®, which comprises its own set of terms, plus terms from a number of other vocabularies.

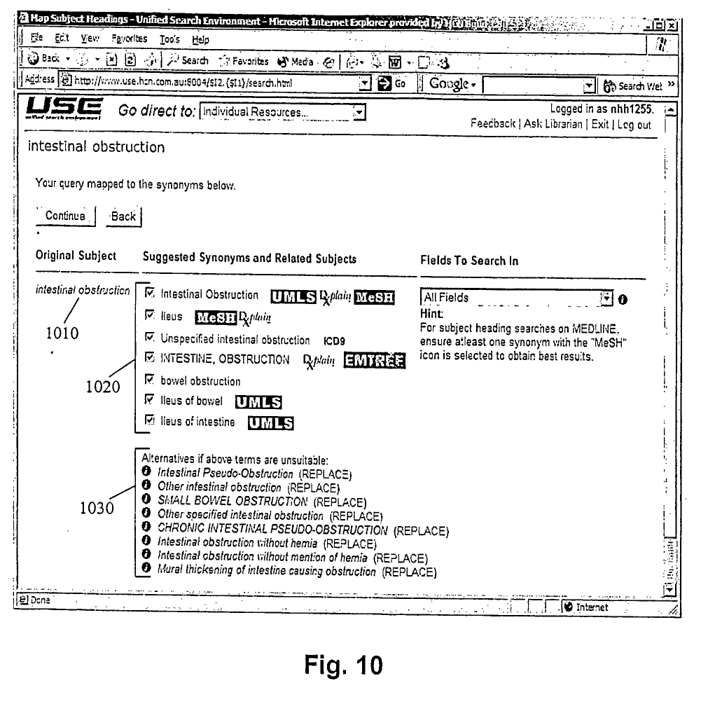

FIG. 10 shows mapping of the subject 1010, which corresponds to the string 910 in FIG. 9, to a set of synonyms 1020. As may be seen from FIG. 10, the term “Intestinal Obstruction” comprises a preferred term for UMLS, Dₓplain term and MeSH®. Similarly, the term “ileus” comprises a preferred ten for MeSH® and Dₓplain, the term “Unspecified intestinal obstruction” comprises a preferred term for ICD9, the term “INTESTINE, OBSTRUCTION” comprises a preferred term for Dₓplain and EMTREE term, and the terms “ileus of bowel” and “ileus of intestine” comprise preferred terms for UMLS. The term “bowel obstruction” does not appear in any of the vocabularies relating to the available databases. A user may select or deselect each synonym in the set of synonyms 1020 by “clicking” on the boxes to the left of the synonyms by means of a pointing device.

One or more from a set of replacement subjects 1030 may be selected by a user to replace the list of synonyms 1010 for the currently mapped subject 1010. It is also possible for a user to add terms from related subjects to the synonyms 1010 of the currently mapped subject 1010.

UMLS, Dₓplain, MeSH®, ICD9, and EMTREE comprise vocabularies for related databases. For example, MeSH® is a vocabulary used by MEDLINE, EMTREE is a vocabulary used by EMBASE, and ICD9 is used in numerous medical record systems.

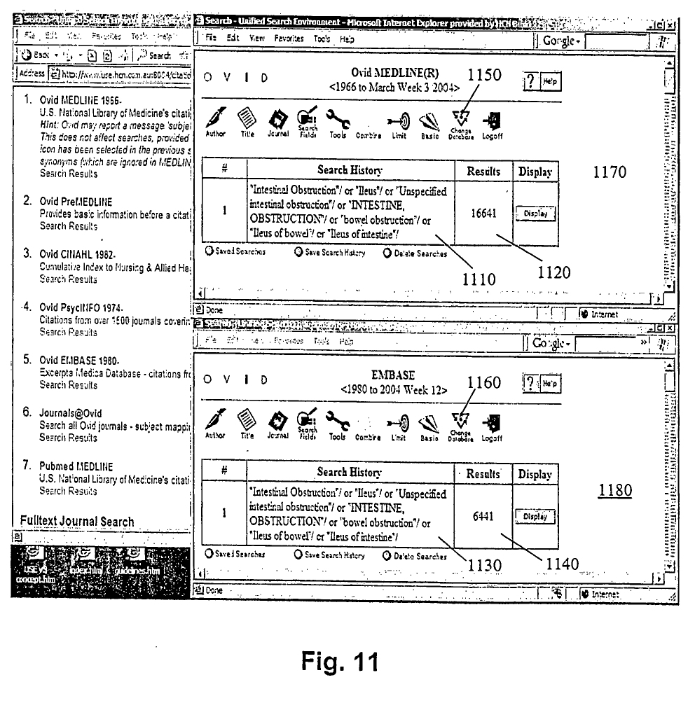

FIG. 11 shows results of searches performed on the Ovid MEDLINE and Ovid EMBASE databases, respectively, using search terms 1110, 1130, which correspond to the multiple search terms or synonyms 1020 selected in FIG. 10. The upper pane 1170 and lower pane 1180 of the screenshot of FIG. 11 show search results from the Ovid MEDLINE and EMBASE databases, respectively. Searching the Ovid MEDLINE database yields 16641 matches 1120 and searching the Ovid EMBASE database yields 6441 matches 1140. The numbers of matches 1120 and 1140 shown in FIG. 11 are higher than the numbers of matches 320 and 740 shown in FIGS. 3 and 7, respectively, on account of the additionally identified MeSH® search term “Ileus” being searched.

The “Change Database” icons 1150 and 1160 may be activated to change database from MEDLINE or EMBASE, respectively.

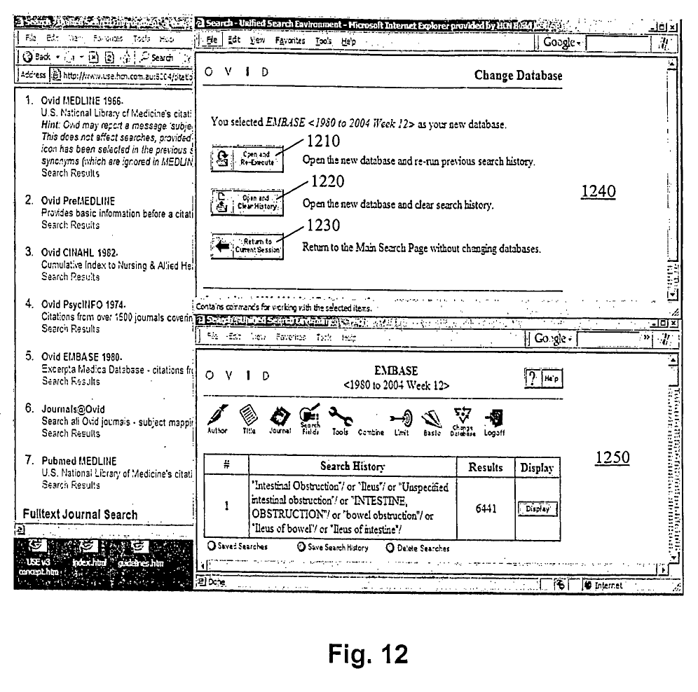

FIG. 12 shows a menu for changing from the MEDDLINE database to the EMBASE database in the upper pane 1240. The lower pane 1250 corresponds to the lower pane 1180 in FIG. 11. Menu option 1210 opens the EMBASE database and re-runs the previous search history (i.e., search history 1110, 1130 as shown in FIG. 11). Menu option 1220 opens the EMBASE database and clears the search history. Menu option 1230 returns a user to the Main Search Page without changing databases.

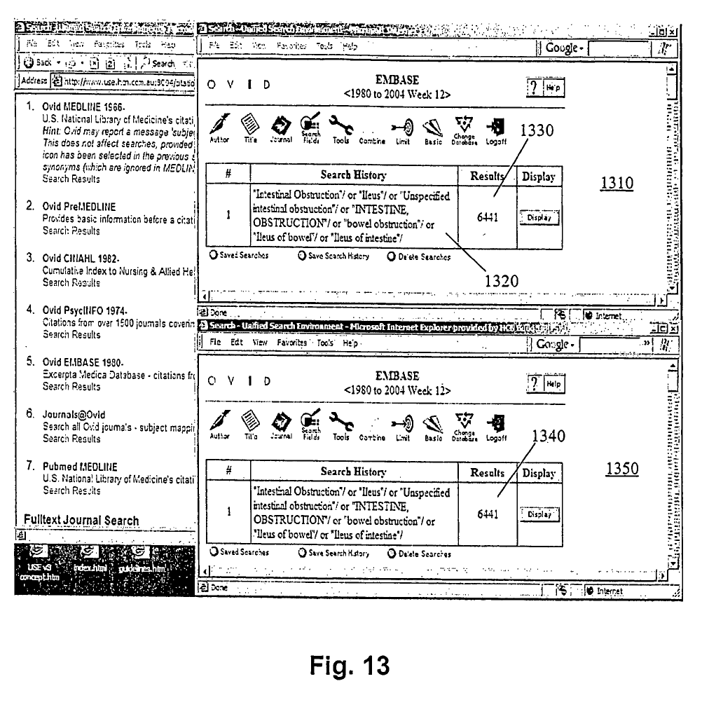

FIG. 13 shows the results of a user selecting menu option 1210 to open the EMBASE database and re-execute the search using the previous search history. As can be seen from the upper pane 1310 of FIG. 13, re-searching the EMBASE database using the previous search history 1320 yields 6441 matches 1330. This search result is the same as the previous search result 1340 obtained from searching the EMBASE database, which is shown in the lower pane 1350 and corresponds to the search result shown in the lower pane 1250 in FIG. 12. This search result is conditional on the meta-thesaurus being used comprising a super-set of the EMTREE vocabulary, which relates to the EMBASE database.

Advantageously, no loss of quality/information results from the user switching between databases on account of the manner in which USE constructs mapped queries using multiple (potentially) redundant terms.

Searching an Information Source

An embodiment of a method for searching an information source or database is described hereinafter.

A search string entered by a user is mapped to a subject. The method used in USE to perform this mapping comprises the following steps:
1. Find subjects with a term, which in their entirety consist only of the search string.
2. If no match from step 1 is available, find subjects with a term differing from the search string only by a spelling variation. The algorithm published by Porter is used to perform this step. Additional information regarding the Porter algorithm may be found in the relevant literature or at the URL: <http://www.tartarus.org/˜martin/PorterStemmer/>, the contents of which are included herein by reference. USE also allows users to override the Porter stemming algorithm, and instead match with a wildcard. For example, Porter stemming will permit the input string “arteries” to be matched to “artery” but not to “arthouse”. However, the search string “art*” will match to both “artery” and “arthouse”. Numerous other matching algorithms including fuzzy matching algorithms such as Levenshtein Edit Distance matching score may also be practised. Additional information regarding the Levenshtein algorithm may be found in the relevant literature or at the URL: <http://www.merriampark.com/ld.htm>, the contents of which are included herein by reference.
3. If no match from step 2 is available, find subjects with a term containing the search string, but also possibly containing additional strings (e.g., if the string “Intestinal Obstruction” was not found in steps 1 and 2, then the subject “Intestinal Obstruction without hernia” could be matched.
4. If no match from steps 1 to 3 is available, search the UMLS Metathesaurus®, which contains a brief definition of each term in the UMLS Metathesaurus®.

The foregoing method generates a list of possible candidate search terms. In addition to ranking these candidates in the above four broad categories, further ranking within categories is performed on the basis of a similarity score. A vector cosine measure algorithm is typically used to calculate this score. Additional information regarding the vector cosine measure algorithm may be found in the relevant literature or at the URL: http://www.cs.ust.hk/faculty/dlee/Papers/ir/ieee-sw-rank.pdf, the contents of which are included herein by reference.

Optional Further Extension

An optional further extension to the embodiments described with reference to FIGS. 8 to 13 is that search strings comprising multiple sub-strings may be mapped to multiple search terms in a single step. The search string is disassembled into multiple sub-strings but the manner in which the sub-strings are combined is preserved.

The disassembly process takes place by determining keyword or phrase boundaries. A dictionary of boundary strings that play a grammatical role in marking out of such boundaries in natural language is maintained, so that search strings that resemble human natural language may be submitted for searching (e.g., “potassium in treatment of intestinal obstruction”). An example of such a dictionary may comprise the set of words: “in”, “with”, “for”, “and”, “or”, and “of”.

The keywords or phrases delimited by such boundaries are extracted and used as search strings for the subject matching algorithm described hereinbefore. Reference designators are substituted into the original search string in place of the extracted keywords or phrases. Additionally, each of the words that match entries in the boundary dictionary is replaced with a Boolean operator by a set of predetermined rules (e.g., the word “with” may be replaced with the operator “AND”, and the word “and” may be (trivially) replaced with the operator “AND”).

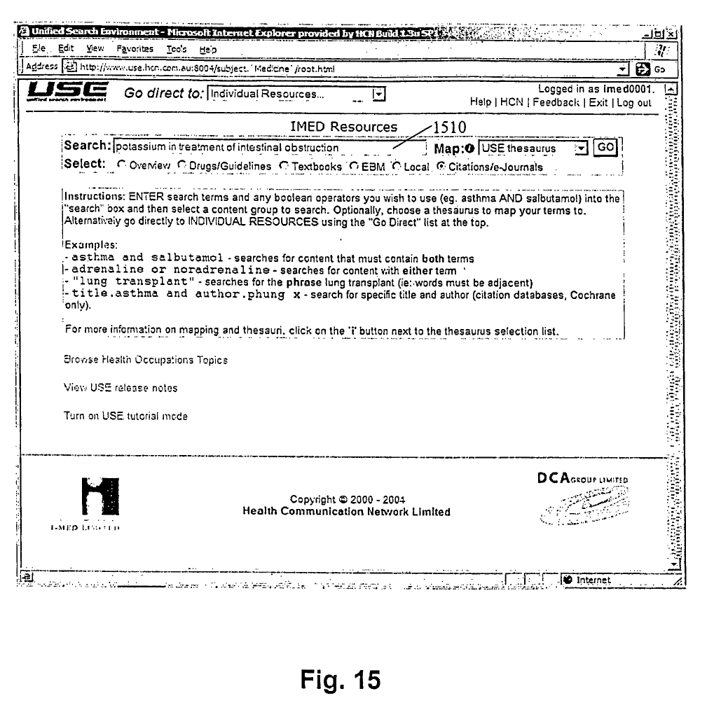

An example of disassembly of the input search string “potassium in treatment of intestinal obstruction” is presented hereinafter. FIG. 15 shows user input of the string “potassium in treatment of intestinal obstruction” 1510 to USE. Thereafter, string 1510 is disassembled into keywords or phrases as follows:
K1. “potassium”
K2. “intestinal obstruction”
K3. “treatment”

Substitution of the reference designators K1, K2, and K3 for the keywords or phrases in the string yields:
“K1 AND K2 AND K3”

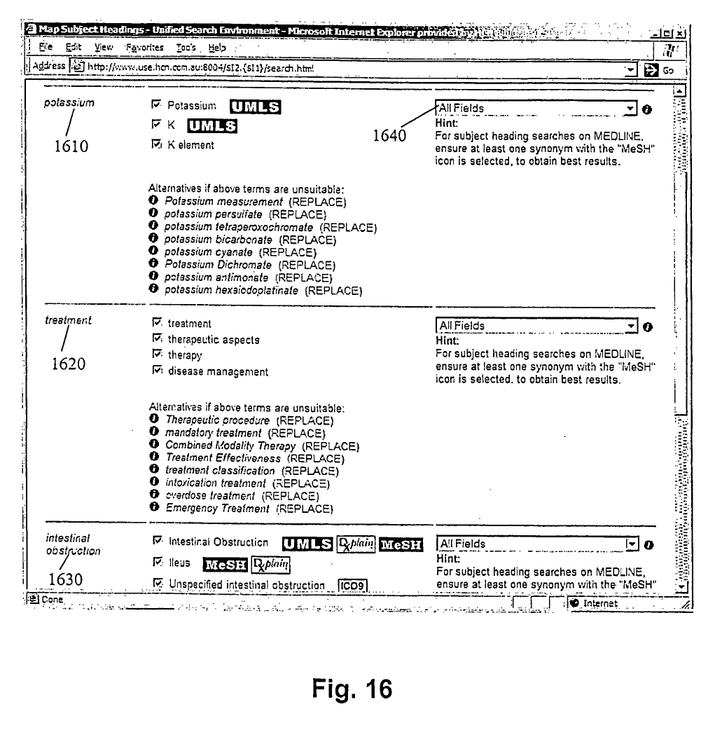

The reference designators K1, K2 and K3 are then mapped in the same manner as a single keyword or phrase and all three mappings 1610, 1620 and 1630 are simultaneously displayed, as shown in FIG. 16. The “Replace” and “Add” functionality described hereinbefore now operates on a specific reference designator K1, K2 or K3 depending on the row in which the “Replace” or “Add” is selected.

Finally, the search terms or synonyms selected by the user are re-inserted in the search string by replacement of the reference designators K1, K2, and K3.

Additionally, ALL the selection checkboxes next to the search terms or synonyms may be de-selected. This results in the term being dropped completely (e.g., if all synonyms of potassium are de-selected, the substituted search query is reassembled as “K2 AND K3”, where K2 and K3 are the synonyms selected for the remaining terms “intestinal obstruction” and “potassium”).

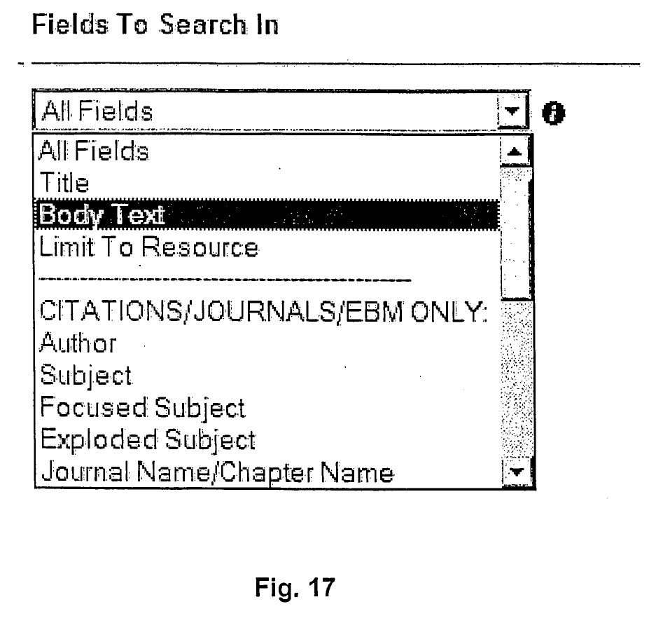

A further feature is that a field list is created for each subject. The fields in a field selection menu 1640 that a user selects from may be customised based on the subject entered. FIG. 17 shows a dropped-down instance of the field selection menu 1640. Field selection occurs simultaneously with mapping, rather than as a separate step.

Existing systems such as Ovid require manual disassembly and separate user entry of each of the sub-strings “potassium” (1), “intestinal obstruction” (2) and “treatment” (3). A separate mapping is performed for each, before manual reassembly by entry of the Boolean expression “1 AND 2 AND 3”.

Computer Hardware and Software

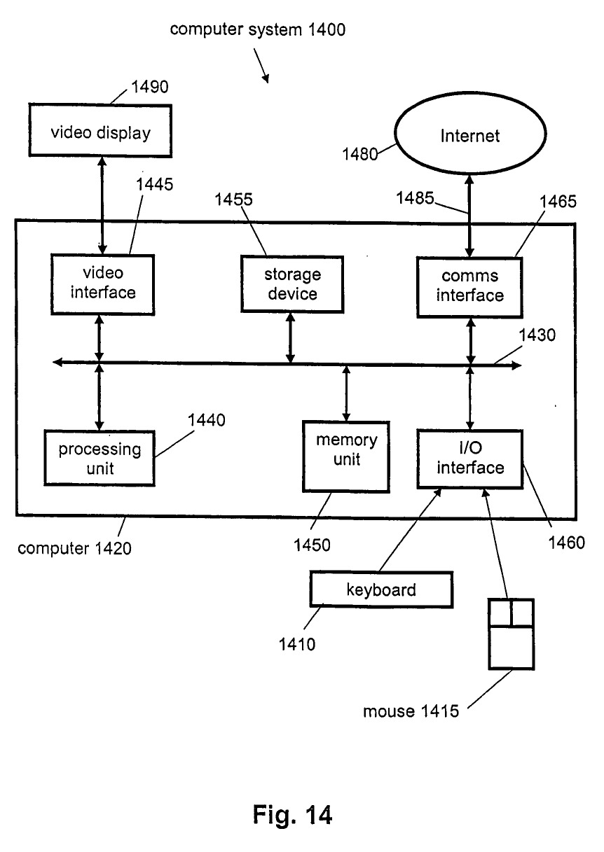

FIG. 14 is a schematic representation of a computer system 1400 that can be used to practise the embodiments described herein. Specifically, the computer system 1400 is provided for executing computer software that is programmed to assist in performing a method for searching a plurality of machine-readable information sources. The computer software executes under an operating system such as MS Windows XP™ or Linux™ installed on the computer system 1400.

The computer software involves a set of programmed logic instructions that may be executed by the computer system 1400 for instructing the computer system 1400 to perform predetermined functions specified by those instructions. The computer software may be expressed or recorded in any language, code or notation that comprises a set of instructions intended to cause a compatible information processing system to perform particular functions, either directly or after conversion to another language, code or notation.

The computer software program comprises statements in a computer language. The computer program may be processed using a compiler into a binary format suitable for execution by the operating system. The computer program is programmed in a manner that involves various software components, or code means, that perform particular steps of the methods described hereinbefore.

The components of the computer system 1400 comprise a computer 1420, input devices 1410, 1415 and a video display 1490. The computer 1420 comprises a processing unit 1440, a memory unit 1450, an input/output (I/O) interface 1460, a communications interface 1465, a video interface 1445, and a storage device 1455. The computer 1420 may comprise more than one of any of the foregoing units, interfaces, and devices.

The processing unit 1440 may comprise one or more processors that execute the operating system and the computer software executing under the operating system. The memory unit 1450 may comprise random access memory (RAM), read-only memory (ROM), flash memory and/or any other type of memory known in the art for use under direction of the processing unit 1440.

The video interface 1445 is connected to the video display 1490 and provides video signals for display on the video display 1490. User input to operate the computer 1420 is provided via the input devices 1410 and 1415, comprising a keyboard and a mouse, respectively. The storage device 1455 may comprise a disk drive or any other suitable non-volatile storage medium.

Each of the components of the computer 1420 is connected to a bus 1430 that comprises data, address, and control buses, to allow the components to communicate with each other via the bus 1430.

The computer system 1400 may be connected to one or more other similar computers via the communications interface 1465 using a communication channel 1485 to a network 1480, represented as the Internet.

The computer software program may be provided as a computer program product, and recorded on a portable storage medium. In this case, the computer software program is accessible by the computer system 1400 from the storage device 1455. Alternatively, the computer software may be accessible directly from the network 1480 by the computer 1420. In either case, a user can interact with the computer system 1400 using the keyboard 1410 and mouse 1415 to operate the programmed computer software executing on the computer 1420.

The computer system 1400 has been described for illustrative purposes. Accordingly, the foregoing description relates to an example of a particular type of computer system suitable for practising the methods and computer program products described hereinbefore. Other configurations or types of computer systems can be equally well used to practise the methods and computer program products described hereinbefore, as would be readily understood by persons skilled in the art. For example, the methods and computer program products described hereinbefore can be practised using a handheld computer such as a Personal Digital Assistant (PDA) or a mobile telephone.

Methods, apparatuses and computer program products have been described hereinbefore for searching a plurality of machine-readable information sources. The foregoing detailed description provides exemplary embodiments only, and is not intended to limit the scope, applicability or configurations of the invention. Rather, the description of the exemplary embodiments provides those skilled in the art with enabling descriptions for implementing an embodiment of the invention. Various changes may be made in the function and arrangement of elements without departing from the spirit and scope of the invention as set forth in the claims hereinafter.

(Australia Only) In the context of this specification, the word “comprising” means “including principally but not necessarily solely” or “having” or “including”, and not “consisting only of”. Variations of the word “comprising”, such as “comprise” and “comprises” have correspondingly varied meanings.

1. A method for searching a plurality of machine-readable information sources, said method comprising the steps of:
mapping a search string to a plurality of search terms, wherein each said search term relates to at least one of said plurality of information sources;
indicating at least one information source that each said search term relates to; and
searching at least one indicated information source using selected ones of said search terms.

2. The method of claim 1, comprising the further steps of receiving said initial search term from a user and providing a result of said search to said user.

3. The method of claim 2, wherein said step of indicating comprises one or more of the steps in the group of steps consisting of:
indicating to said user which of said plurality of information sources each of said search terms relates to; and
indicating to said user at least one vocabulary each said search term is included in, wherein each vocabulary relates to at least one of said information sources.

4. The method of claim 3, comprising the further step of enabling said user to select and de-select ones of said plurality of information sources whereon said searching step is performed.

5. The method of claim 3, comprising the further step of enabling said user to replace ones of said plurality of search terms with replacement search terms.

6. The method of claim 3, comprising the further step of enabling said user to add further search terms to said plurality of search terms.

7. The method of claim 1, wherein each of said plurality of search terms is selected from a vocabulary of terms used in a related one of said plurality of information sources.

8. The method of claim 1, wherein said plurality of search terms are selected from a meta-vocabulary comprising a list of terms included in a plurality of vocabularies.

9. The method of claim 1, wherein said plurality of information sources comprise medical databases.

10. The method of claim 1, wherein said mapping step is performed once only for searching a particular search string.

11. The method of claim 1, wherein said search string comprises a plurality of terms and said step of mapping comprises the step of mapping each of said plurality of terms to a plurality of synonyms.

12. An apparatus for searching a plurality of machine-readable information sources, said apparatus comprising:
a communications interface for transmitting and receiving data;
a memory unit for storing data and instructions to be performed by a processing unit; and
a processing unit coupled to said communications unit and said memory unit, said processing unit programmed to:
map a search string to a plurality of search terms, wherein each said search term relates to at least one of said plurality of information sources;
output an indication of at least one information source that each said search term relates to; and
search at least one indicated information source using selected ones of said search terms.

13. The apparatus of claim 12, wherein said processing unit is further programmed to receive said search string from a user and to output a result of said search to said user.

14. The apparatus of claim 12, wherein said processing unit is programmed to perform one or more instructions from the group of instructions consisting of:
indicate which of said plurality of information sources each of said search terms relates to; and
indicate at least one vocabulary each said search term is included in, wherein each vocabulary relates to at least one of said information sources.

15. The apparatus of claim 12, wherein said processing unit is further programmed to enable selection and de-selection of ones of said plurality of information sources whereon said searching is performed.

16. The apparatus of claim 12, wherein said processing unit is further programmed to enable replacement of ones of said search terms with replacement search terms.

17. The apparatus of claim 12, wherein said processing unit is further programmed to enable further search terms to be added to said plurality of search terms.

18. The apparatus of claim 12, wherein said processing unit is programmed to select each of said search terms from a vocabulary of terms used in a related one of said plurality of information sources.

19. The apparatus of claim 12, wherein said processing unit is programmed to select said search terms from a meta-vocabulary comprising a list of terms included in a plurality of vocabularies.

20. The apparatus of claim 12, wherein said plurality of information sources comprise medical databases.

21. The apparatus of claim 12, wherein said initial search term is mapped once only for searching a particular search string.

22. The apparatus of claim 12, wherein said search string comprises a plurality of terms and said processing unit is further programmed to map each of said plurality of terms to a plurality of synonyms.

23. A computer program product comprising a computer readable medium having a computer program recorded therein for searching a plurality of information sources, said computer program product comprising:
computer program code for mapping a search string to a plurality of search terms, wherein each said search term relates to at least one of said plurality of information sources;
computer program code for outputting an indication of at least one information source that each said search term relates to; and
computer program code for searching at least one indicated information source using selected ones of said search terms.

24. The computer program product of claim 23, further comprising computer program code for enabling a user to submit said initial search term.

25. The computer program product of claim 23, wherein said computer program code for outputting comprises one or more computer program code selected from the group of computer program code consisting of:
computer program code for indicating which of said plurality of information sources each of said search terms relates to; and
computer program code for indicating at least one vocabulary each said search term is included in, wherein each vocabulary relates to at least one of said information sources.

26. The computer program product of claim 23, further comprising computer program code for enabling selection and de-selection of ones of said plurality of information sources whereon said searching is performed.

27. The computer program product of claim 23, further comprising computer program code for enabling replacement of ones of said search terms with replacement search terms.

28. The computer program product of claim 23, further comprising computer program code for enabling addition of further search terms to said plurality of search terms.

29. The computer program product of claim 23, further comprising computer program code for selecting each of said plurality of search terms from a vocabulary of terms used in a related one of said plurality of information sources.

30. The computer program product of claim 23, further comprising computer program code for selecting said plurality of search terms from a meta-vocabulary comprising a list of terms included in a plurality of vocabularies.

31. The computer program product of claim 23, wherein said plurality of information sources comprise medical databases.

32. The computer program product of claim 23, wherein said initial search term is mapped once only for searching a particular search string.

33. The computer program product of claim 23, wherein said search string comprises a plurality of terms and said computer program code for mapping comprises computer program code for mapping each of said plurality of terms to a plurality of synonyms.

34. A method for searching a plurality of machine-readable information sources, said method comprising the steps of:
mapping a search string to a plurality of search terms, wherein each said search term relates to at least one of said plurality of information sources; and
searching at least one information source using selected ones of said search terms.

35. An apparatus for searching a plurality of machine-readable information sources, said apparatus comprising:
a communications interface for transmitting and receiving data;
a memory unit for storing data and instructions to be performed by a processing unit; and
a processing unit coupled to said communications unit and said memory unit, said processing unit programmed to:
map a search string to a plurality of search terms, wherein each said search term relates to at least one of said plurality of information sources; and
search at least one information source using selected ones of said search terms.

36. A computer program product comprising a computer readable medium having a computer program recorded therein for searching a plurality of information sources, said computer program product comprising:
computer program code for mapping a search string to a plurality of search terms, wherein each said search term relates to at least one of said plurality of information sources; and
computer program code for searching at least one information source using selected ones of said search terms.
